(19) United States
(12) Patent Application Publication
(10) Pub. No.: US 2008/0110066 A1
(43) Pub. Date: May 15, 2008

(54) SPORTS MEMORABILIA DISPLAY STAND

(76) Inventor: Peter Peroni, Pottstown, PA (US)

Correspondence Address: Connolly Bove Lodge & Hutz, LLP, P.O. Box 2207, Wilmington, DE, 19899-2207, US

(21) Appl. No.: 11/558,129

(22) Filed: Nov. 9, 2006

(51) Int. Cl. G09F 19/02

(52) U.S. Cl. 40/430; 206/315.1; 428/13; 206/459.5; 40/414

(57) ABSTRACT

A sports memorabilia display stand includes a base having a motor operated rotatable drive mechanism for driving a display pillar assembly extending upwardly from the base. A support pedestal is mounted to the display pillar assembly for rotation therewith and a sports memorabilia item is placed on the support pedestal. A music box may be incorporated in the base to play songs or speeches or other information consistent with the theme of the particular sport. At least one auxiliary sports item may be mounted on the display pillar assembly.

### BACKGROUND OF THE INVENTION

Various types of sports memorabilia exist which are collectible and often displayed. While different types of displays are known it would be desirable if a display could be provided which permits the sports memorabilia item to be prominently displayed and particularly in a manner that enhances the theme of the sport or sports memorabilia display item.

It is known to have switch actuated music boxes including music boxes which contain rotating items such as a Christmas tree. Such music boxes, however, are not used for displaying externally mounted sports memorabilia items.

### SUMMARY OF THE INVENTION

An object of this invention is to provide a sports memorabilia display stand for prominently displaying various memorabilia items.

A further object of this invention is to provide such a sports memorabilia stand that permits the item to be rotated and could also contain some audio, such as a song or speech consistent with the item.

A still further object of this invention is to provide such a sports memorabilia display stand which includes auxiliary items consistent with that sport.

In accordance with this invention a sport memorabilia display stand includes a base having a motor operated rotatable drive mechanism. A display pillar assembly extends upwardly from the base for mounting a support pedestal which would hold the memorabilia item. The display pillar assembly is operatively connected to the drive mechanism so that it can be selectively rotated about an axis extending longitudinally through the display pillar assembly and thereby rotate the support pedestal. The base may incorporate a music box for containing audio with the same theme as the sport of that sport memorabilia item. An audio control member would permit the selective actuation of the audio. Alternatively, or in addition, at least one auxiliary sports item may also be provided which is of the same theme of the sports memorabilia item.

Various types of sports memorabilia items may be displayed. For example, where the item is a baseball the ball could be held in a cup shaped support. Auxiliary items could include simulated bats. Various inserts, such as team logos, could be mounted to the display pillar.

Where the item is a football the item could be displayed by having the support pedestal in the form of a kicking tee. Another variation would be to have the support pedestal simulate a football field and have the football mounted on the field.

Other types of items could be displayed on the appropriate support pedestal with corresponding audio and/or auxiliary items.

### THE DRAWINGS

FIG. 1 is a top plan view of a sport memorabilia display stand in accordance with this invention;

FIG. 2 is a front elevational and cross-sectional view of the stand shown in FIG. 1 wherein the cross-section is taken along the line 2-2 of FIG. 1;

FIG. 3 is a bottom plan view of the support pedestal shown in the stand of FIGS. 1-2;

FIG. 4 is a top plan view of an alternative form of stand in accordance with this invention;

FIG. 5 is a front elevational view of a portion of the stand shown in FIG. 4;

FIG. 6 is a side elevational view of yet another form of stand in accordance with this invention;

FIG. 7 is a front elevational view of the support pedestal used in FIG. 6;

FIG. 8 is a front elevational view of yet another stand in accordance with this invention; and

FIGS. 9-10 are top plan views of still further stands in accordance with this invention.

### DETAILED DESCRIPTION

The present invention generally comprises a sports memorabilia display stand which includes a base having a motor operated rotatable drive mechanism. A display pillar assembly extends upwardly from the base on which is mounted a support pedestal which in turn supports the sports memorabilia item. The stand may include a music box for providing audio consistent with the sport of that item and/or may include various auxiliary sports items consistent with the sport of that item.

The sports item may be of various sports. One form of sports could involve the use of balls, such as baseball, basketball, football, volleyball, soccer, etc. Other types of sports may include hockey, track, etc. Further, the display stand may also be used for such sports as race car driving or fishing. It is to be understood that the specific embodiments shown and described herein are merely exemplary of the various manners in which the invention may be practiced.

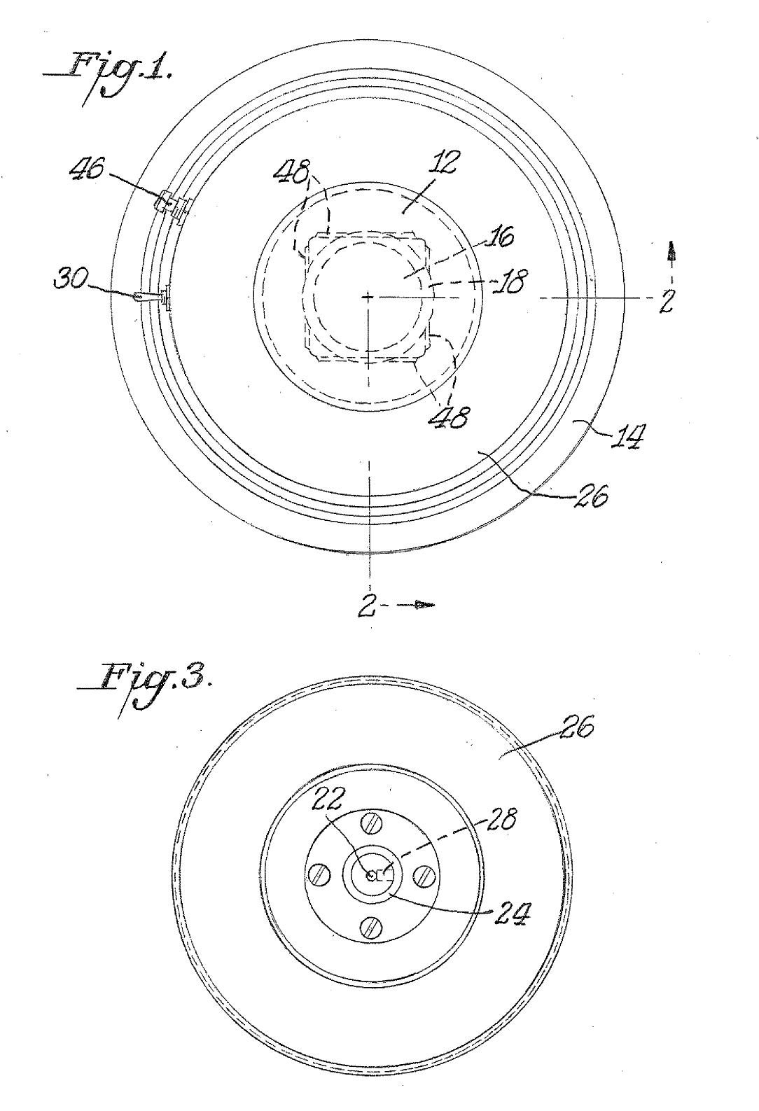

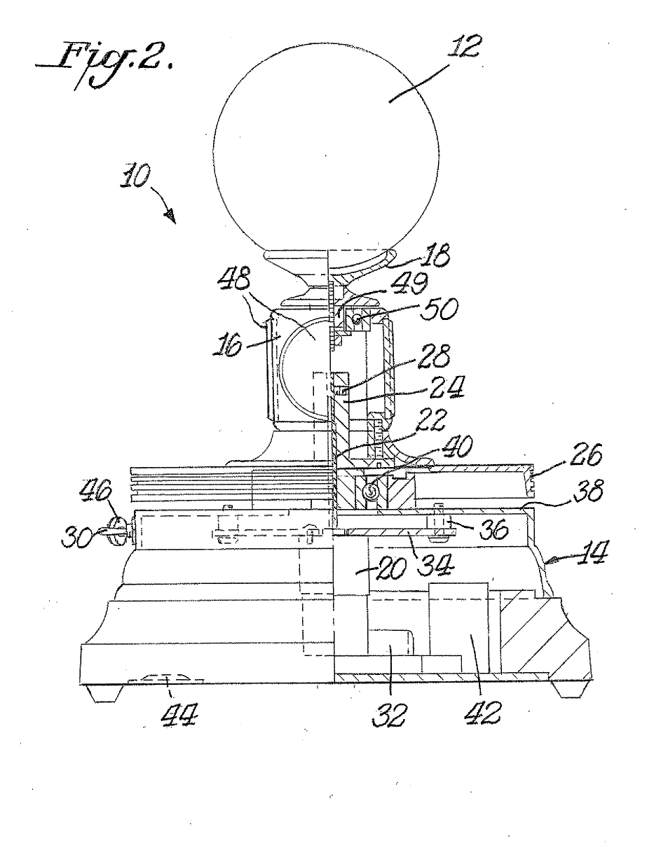

FIGS. 1-3, and in particular FIG. 2, illustrate one practice of this invention wherein the sports memorabilia display stand 10 is used for displaying a spherical sports item 12 which could be a baseball, basketball, soccer ball, volleyball, etc. As shown therein the stand 10 includes a base 14 which would house the various mechanisms for selectively rotating the sports item being displayed. A display pillar assembly including a vertical pillar 16 is mounted to and extends upwardly from the base 14. A support pedestal 18 is mounted to the vertical display pillar 16 for holding the sports item 12.

Base 14 could be of any suitable shape since the shape itself is not critical in the practice of the invention. Rather a shape would be selected from an aesthetic standpoint and, if desired, for compactness in minimizing the space taken should that be a consideration. Base 14 is essentially a hollow stepped cylindrical housing having a suitable motorized drive for rotating the sports item 12 so that essentially all portions of the item can be prominently displayed when desired. Various types of suitable drive mechanisms include a gear motor, a belt drive or a capstan. In the illustrated embodiment a drive motor 20 rotates a shaft 22 extending into a spindle 24 in the display pillar assembly. The primary components of the display pillar assembly are a carriage 26 and the vertical pillar 16. Carriage 26 is in the form of a generally flat disk having a downwardly extending peripheral skirt which may be ribbed. Carriage 26 is of the same circular shape as the top of base 14 to be located above and slightly spaced from base 14 while appearing to be a continuation of base 14. Spindle 24 is mounted to and internally of carriage 26. Pillar 16 is mounted to and extends upwardly from carriage 26. A set screw 28 selectively connects spindle 24 to shaft 22 to permit engagement/disengagement of the shaft and spindle as desired. Thus, when shaft 22 rotates, spindle 24 also rotates causing the entire display pillar assembly to rotate and thereby also rotate support pedestal 18 and item 12.

The actuation of the rotatable drive mechanism may be controlled by a rotation actuating member or switch 30 mounted to and exposed from base 14 in any suitable manner.

Drive motor 20 may be powered in any suitable manner such as by an electric cord plugged into a wall socket. Preferably, however, as illustrated, drive motor 20 is operated by batteries 32 in a suitable battery case in base 14. A motor mounting plate 34 is located in base 14 and is secured by suitable fasteners 36 to the top wall 38 of base 14. Top wall 38 supports ball bearings 40 which facilitate the rotation of support disk, 26 spindle 24 and the display pillar assembly.

In accordance with one embodiment of this invention a music box 42 is mounted in base 14. Music box 42 may be of any known form as is conventionally used with music boxes. As regards the present invention music box 42 would be provided with suitable speakers 44 and with an audio control member, such as push button 46 which is mounted to and exposed from base 14 for selectively turning the audio from the music box on and off. Music box 14 would preferably include, for example, songs or speeches or other audio information consistent with the theme of the particular sport of that sports memorabilia item 12. Where, for example, the sports memorabilia item 12 is a baseball, the music might be a traditional song such as “Take me out to the ballgame”. Where the sports item is a football, the audio could be a motivational speech. Where the sports item is relating to fishing or boating the music could be of a soothing, soft nature such as the tune “Sailing” consistent with that activity.

Carriage or disk 26 comprises the lower portion of the display pillar assembly. The vertical portion 16 of the display pillar assembly is desirable to add height to the display stand 10 and also to provide surface area for auxiliary sports items. Thus, for example, display inserts 48 could be mounted to the surface of pillar 16. Such insert 48 could contain a logo or some identification or other information consistent with the sport of the sports memorabilia item 12. Where pillar 16 is made with a square cross-section there would be four sides to permit four different inserts 48. Other shapes, such as circles, triangles, hexagons, etc. could also be used to accommodate different types of inserts.

If desired, motor 20 could be a reversible motor so that the direction of push of switch 30 would control the direction of rotation of the display pillar 16 and support pedestal 18. There would be no rotation when switch 30 is in the central straight position. The invention could also be practiced where the display pillar assembly is stationary and only the support pedestal 18 rotates. This could easily be done by having the motor shaft or some connection to the motor shaft extend through carriage 26 and display pillar 16 and then be connected to a spindle in display pedestal 18.

In a preferred practice of this invention the simulated sports item 12 is rotated by rotating the display pillar assembly through selective actuation of the switch 30. Where the support pedestal 18 is rigidly mounted to pillar 16 support pedestal 18 would necessarily rotate along with pillar 16. FIG. 2 illustrates a preferred practice of the invention wherein the pedestal support 18 is placed on pillar 16 and is free to rotate independently of pillar 16. This is accomplished by a shaft 49 extending downwardly from the lower portion of support pedestal 18 into pillar 16 inwardly of bearings 50. In operation when switch 30 is actuated the display pillar assembly rotates and by having the pedestal support mounted on the pillar 16 the pedestal support 18 rotates along with the pillar 16. When switch 30 is in its off position, however, it is still possible to manually rotate pedestal support 18 by simply manipulating, for example, the item 12 and rotation is permitted by virtue of the shaft 49 rotating in bearings 50. This makes it possible to re-orient or to view different portions of the item 12 without having to rotate the entire display pillar assembly.

The size and shape of display pedestal 18 would be selected to best display the item 12. As shown in FIG. 2 support pedestal 18 is dished or cup shaped so that, for example, a sphere or ball could be readily detachably placed in the cup shaped upper surface of support pedestal 18. Alternatively, the invention could be practiced where the sports item is permanently fixed, such as by adhesive or other means to the support pedestal 18.

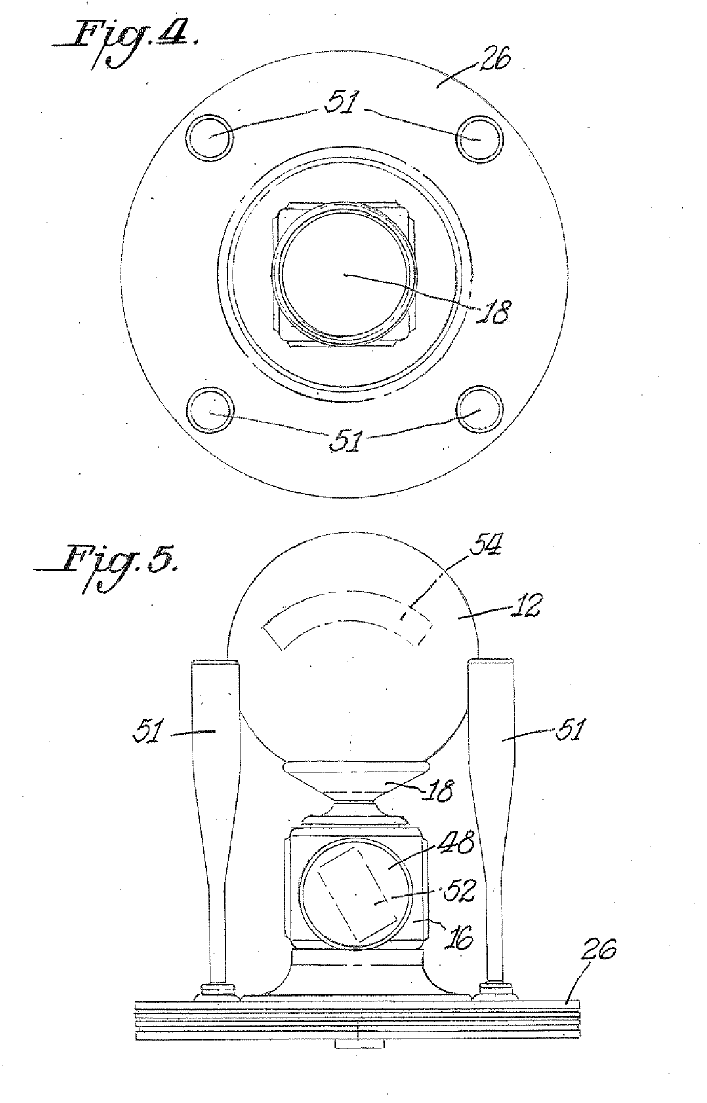

FIGS. 4-9 exemplify different practices in accordance with this invention. In each of these figures the base is not shown and would generally be along the lines of base 14 illustrated in FIGS. 1-3. What these figures illustrate are various manners of displaying different types of sports memorabilia and auxiliary sports items.

FIGS. 4-5 show an embodiment of the invention wherein the display pillar assembly is used to mount a pedestal support 18 for displaying a baseball 12. In addition to the sports memorabilia item or baseball 12, auxiliary sports items are also included on the display stand. The illustrated auxiliary sports items include a plurality of simulated baseball bats 51 mounted in an upright position on the top of carriage or disk 26 of the display pillar assembly. Although the simulated baseball bats are shown to be in an upright position and four in number, any other orientation and/or number of bats may also be used. In addition, the pedestal support 18 could be in the form of a baseball glove rather than of a more simplified cup structure. The inserts 48 on the upright pillar 16 could include such items as a team logo 52. The baseball itself may also include an area 54 which displays a team name. Other informational and/or sports items may be provided on the display pillar assembly.

The baseball 12 could be an actual baseball such as an authentic autographed baseball or could be a simulated baseball. For example, the baseball 12 or other item could be a weighted ball made in accordance with the teachings of copending application Ser. No. 11/468,051 filed Aug. 29, 2006, all of the details of which are incorporated herein by reference thereto. A weighted ball is a particularly desirable item to display since its weight assists in reliably mounting the ball in a support pedestal with most of the ball visible for viewing.

Other variations of the baseball theme that could be incorporated in the display stand include cast homeplates and cast bats; spinners or rotatable display pillars, such as zinc-cast; brushed black nickle plated finished spinner that includes homeplates and cast bats; a second spinner having a simple pedestal or pillar without bats or homeplate; two bats or two pair of crossed bats.

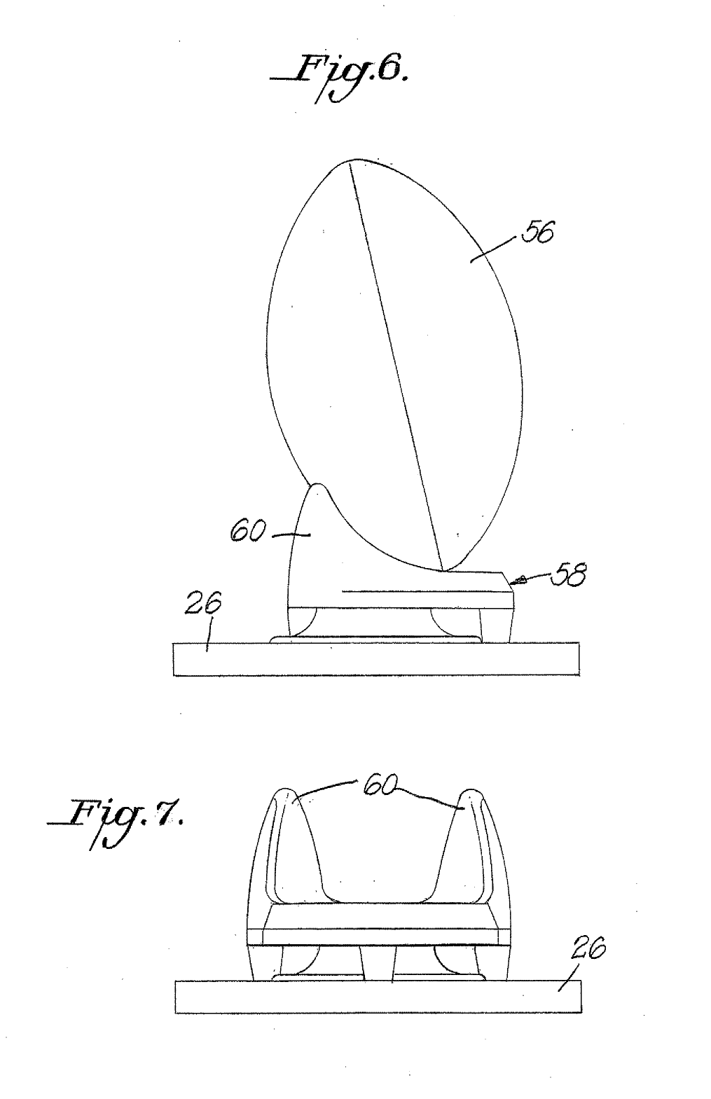

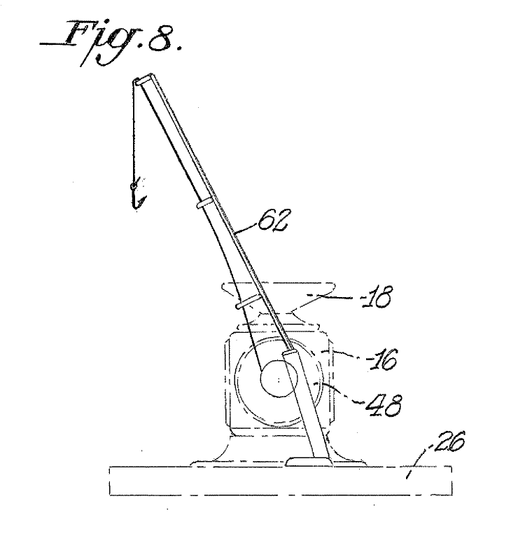

FIGS. 6-7 show a further variation wherein the display pillar assembly is used for displaying an actual or a simulated football 56. In this embodiment the support pedestal is in the form of a kicking tee 58 having three upstanding members 60 which form a cradle for the football. The kicking tee would be mounted directly on the carriage or disc 26.

FIG. 8 shows a variation of the invention wherein the sports theme is fishing or sailing. The support pedestal 18 could be used for holding any suitable sports memorabilia item such as a simulated boat. The auxiliary sports item could be anything consistent with that theme such as a fishing rod 62 which could be mounted directly to the carriage 26 of the display pillar assembly. As illustrated the pillar 16 could be provided to include various inserts 48 having informational material relating to that specific sport or illustrating photographs, logos, etc.

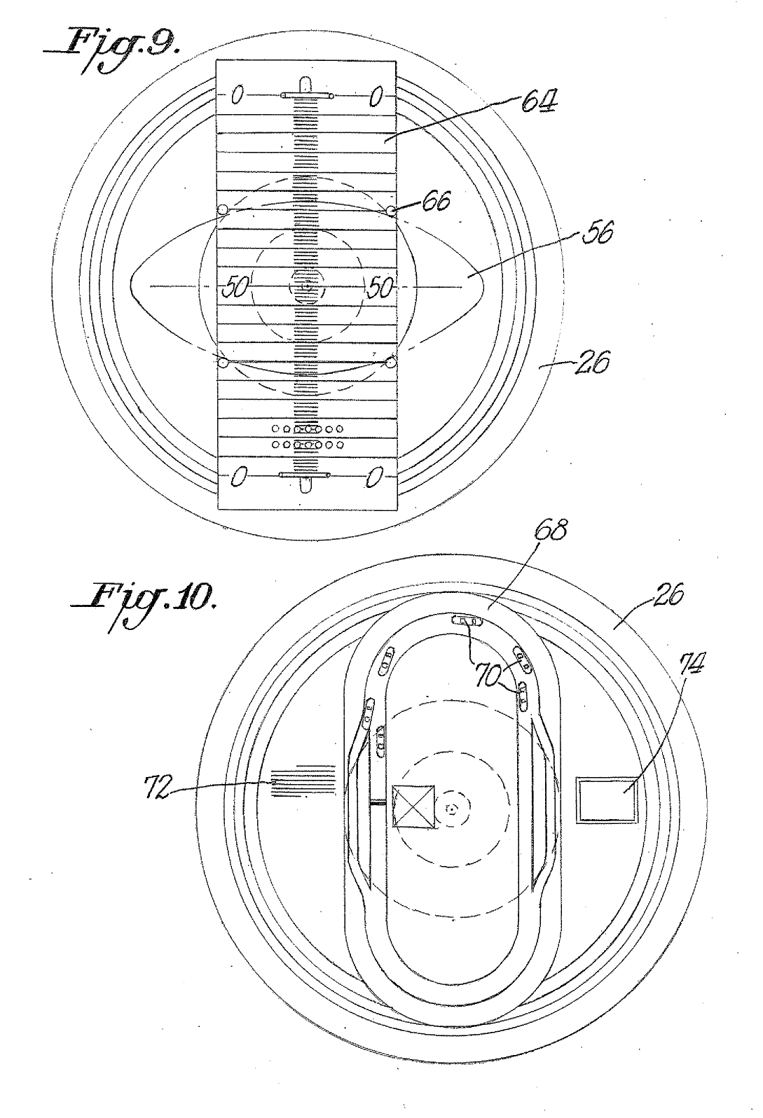

FIG. 9 illustrates yet a further variation of the invention wherein the sports memorabilia item is a football 56. The support pedestal, however, is in the form of a simulated football field 64. Any suitable mounting structure such as a series of upstanding pins 66 could be used for creating a cradle onto which the football 56 would be placed to be elevated above the simulated football field 64 or also in contact with the simulated football field 64.

FIG. 10 illustrates a further practice of the invention wherein the display pillar assembly is used for a race car theme, such as NASCAR. As shown therein, the support pedestal 68 could be a simulated 3-D race track and could be one which accurately simulates an actual specific racetrack. The sports items could be miniature race cars 70 located either permanently at fixed locations on the track 68 or free to move on the track by simply being placed as independent items on the track. The carriage 26 could be used to enhance the race car theme such as providing an area 72 having information, for example, relating to the specific race track. In addition, there could be a souvenir area 74 which might hold actual souvenirs such as pieces of stone, grass, etc. from the track. The souvenir could be a piece of the track or a portion of a seat from an actual spectator portion of the track. Where the track 68 simulates an actual track it would have inclined or banked areas and would have a shape which simulates the oval track portion and the off track pits areas.

As an enhancement or an alternative to the race car theme shown in FIG. 10 the display stand could include a license plate frame either as an auxiliary sports item or even to function as the support pedestal.

As is apparent the invention could be practiced to provide a display of sports items of various different natures from various different sports. The display stand effectively exhibits the item which is enhanced by the ability to rotate the item and could further be enhanced by providing audio relating to the item.

What is claimed is:

1. A sports memorabilia display stand comprising a base, a motor operated rotatable drive mechanism mounted in said base, a display pillar assembly extending upwardly from said base, a support pedestal mounted to said display pillar assembly, said support pedestal being rotatable in response to rotation of said drive mechanism for rotation along an axis extending vertically through said display pillar assembly, a rotation actuating member mounted to and exposed from said base for selective actuation of the rotation of said drive mechanism and said support pedestal, a sport memorabilia item mounted on said support pedestal, a music box in said base for containing audio which may be of the same theme as the sport of said sports memorabilia item, and an audio control member mounted to and exposed from said base for selectively turning the audio on and off.

2. The stand of claim 1 wherein said display pillar assembly includes a carriage mounted on said base, and said carriage being rotated by said drive mechanism.

3. The stand of claim 2 wherein said support pedestal is also manually rotatable independently of the rotation of said carriage.

4. The stand of claim 2 wherein said sports memorabilia item is a weighted ball.

5. The stand of claim 4 wherein said item is a baseball, and at least one simulated baseball bat mounted to said display pillar assembly.

6. The stand of claim 2 wherein said display pillar assembly includes an upstanding pillar mounted to and extending vertically outwardly from said carriage, and at least one display insert mounted to said pillar.

7. The stand of claim 2 wherein said sports memorabilia item is a basketball.

8. The stand of claim 2 wherein said sports memorabilia item is a football.

9. The stand of claim 8 wherein said support pedestal includes a simulated kicking tee, and said football being mounted on said kicking tee.

10. The stand of claim 8 wherein said support pedestal is a simulated football field, said sports memorabilia item being a football, and said football being mounted on said football field.

11. The stand of claim 1 wherein said support pedestal is a simulated race track, and said sports memorabilia item being at least one simulated race car placed on said race track.

12. The stand of claim 11 including a souvenir holder on said display pillar assembly for holding a souvenir representative of said race track.

13. The stand of claim 1 wherein said sport memorabilia item is readily removable from said sports pedestal by lifting said item away from said pedestal.

14. A sports memorabilia display stand comprising a base, a motor operated rotatable drive mechanism mounted in said base, a display pillar assembly extending upwardly from said base, a support pedestal mounted to said display pillar assembly, said support pedestal being rotatable in response to rotation of said drive mechanism for rotation along an axis extending vertically through said display pillar assembly, a rotation actuating member mounted to and exposed from said base for selective actuation of the rotation of said drive mechanism and said support pedestal, a sport memorabilia item mounted on said support pedestal, said display pillar assembly having an auxiliary sports item, and said auxiliary sports item being of the same theme as the sport of said sports memorabilia item.

15. The stand of claim 14 wherein said display pillar assembly includes a carriage mounted on said base, and said carriage being rotated by said drive mechanism.

16. The stand of claim 15 wherein said support pedestal is also manually rotatable independently of the rotation of said carriage.

17. The stand of claim 15 wherein said sports memorabilia item is a weighted ball.

18. The stand of claim 15 wherein said item is a baseball, and at least one simulated baseball bat mounted to said display pillar assembly.

19. The stand of claim 15 wherein said display pillar assembly includes an upstanding pillar mounted to and extending vertically outwardly from said carriage, and at least one display insert mounted to said pillar.

20. The stand of claim 15 wherein said sports memorabilia item is a basketball.

21. The stand of claim 15 wherein said sports memorabilia item is a football.

22. The stand of claim 21 wherein said support pedestal includes a simulated kicking tee, and said football being mounted on said kicking tee.

23. The stand of claim 21 wherein said support pedestal is a simulated football field, said sports memorabilia item being a football, and said football being mounted on said football field.

24. The stand of claim 14 wherein said support pedestal is a simulated race track, and said sports memorabilia item being at least one simulated race car placed on said race track.

25. The stand of claim 24 including a souvenir holder on said display pillar assembly for holding a souvenir representative of said race track.

26. The stand of claim 14 wherein said sport memorabilia item is readily removable from said sports pedestal by lifting said item away from said pedestal.
